(19) United States
(12) Patent Application Publication
(10) Pub. No.: US 2026/0011903 A1
(43) Pub. Date: Jan. 8, 2026

(54) SLOT-COUPLING TYPE COUPLER

(71) Applicant: NTT, Inc., Tokyo (JP)

(72) Inventors: Adam Pander, Tokyo (JP); Daisuke Kitayama, Tokyo (JP)

(21) Appl. No.: 19/111,521

(22) PCT Filed: Sep. 16, 2022
(86) PCT No.: PCT/JP2022/034781

§ 371 Date: Mar. 13, 2025

(51) Int. Cl. H01P 5/107

(52) U.S. Cl. CPC H01P 5/107

(57) ABSTRACT

An embodiment is a slot-coupling type coupler for connecting a high-frequency circuit to a waveguide tube. The coupler includes a substrate, at least a part of the substrate being inserted into the waveguide tube, and a conductor patch on the substrate and configured to emit a high-frequency wave generated by the high-frequency circuit into the waveguide tube. The conductor patch comprises a first conductor patch on a first side of the substrate and includes a complementary metamaterial cell including one or more conductor portions forming one or more gaps.

### CROSS-REFERENCE TO RELATED APPLICATIONS

This application is a national phase entry of PCT Application No. PCT/JP2022/034781, filed on Sep. 16, 2022, which application is hereby incorporated herein by reference.

### TECHNICAL FIELD

The present invention relates to a slot-coupling type coupler that connects a high-frequency circuit to a waveguide tube.

### BACKGROUND

The increased demand for higher data transmission rates caused the rapid development of electronics for information technology, including wireless systems, radar, sensing, etc. To realize such systems, high-frequency bands, 30 GHz to 300 to 500 GHz millimeter wave bands, etc. became the major candidate for the development of various devices. In addition, the connection technology that connects high-frequency circuits and waveguide tubes is important in the use of such high-frequency bands.

There are three types of couplers that connect high-frequency circuits to waveguide tubes: probe-insertion type, impedance type, and slot coupling type. Of these, the slot-coupling type coupler, as disclosed by Non-Patent Literature 1, has a substrate that is inserted into the waveguide tube and a conductor patch provided on the substrate for emitting the high-frequency wave from the high-frequency circuit into the waveguide tube. Since the slot-coupling type coupler has a planar structure, it can be relatively easily implemented in high-frequency band applications.

### Citation List

### Non Patent Literature

NPL 1-N. Kaneda, Yongxi Qian and T. Itoh, “A broadband microstrip-to-waveguide transition using a quasi-Yagi antenna,” 1999 IEEE MTT-S International Microwave Symposium Digest (Cat. No. 99CH36282), 1999, pp. 1431-1434 vol. 4, doi: 10.1109/MWSYM.1999.780218.

### SUMMARY

### Technical Problem

However, slot-coupling type couplers can cause large transmission loss in high-frequency bands.

Embodiments of the present invention has been made to reduce transmission loss in the high-frequency band in slot-coupling type couplers.

### Solution to Problem

In order to solve the above problem, the slot-coupling type coupler according to embodiments of the present invention is a slot-coupling type coupler for connecting a high-frequency circuit to a waveguide tube, comprising a substrate, at least a part of the substrate being inserted into the waveguide tube; and a conductor patch provided on the substrate and configured to emit a high-frequency wave generated by the high-frequency circuit into the waveguide tube, the conductor patch comprising a first conductor patch which is provided on a first side of the substrate and includes a complementary metamaterial cell including one or more conductor portions forming the one or more gaps.

According to the above configuration, the transmission loss in the high-frequency band is reduced.

### BRIEF DESCRIPTION OF THE DRAWINGS

FIG. 1 shows a schematic diagram of a slot-coupling type coupler of a first embodiment.

FIG. 2 shows examples of plan views of the geometries of complementary metamaterial cells included in a conductor patch.

FIG. 3 illustrates various geometric parameters of the complementary metamaterial cell of FIG. 2 (b).

FIG. 4 shows an equivalent circuit diagram of the complementary metamaterial cell of FIG. 3.

FIG. 5 shows a schematic diagram of the complementary metamaterial cell for simulation.

FIG. 6 shows spectrum diagrams of simulation results showing the frequency characteristics of the element S21 (transmission coefficient) and the element S11 (reflection coefficient) of the S-parameters of the configuration shown in FIG. 5.

FIG. 7 shows spectrum diagrams of simulation results showing the frequency characteristics of the element S11 and S22 (reflection coefficient) and the element S21 (transmission coefficient) of the S-parameters of a slot-coupling type coupler without complementary metamaterial cells.

FIG. 8 shows spectrum diagrams of simulation results showing the frequency characteristics of the element S11 of the S-parameters of the slot-coupling type coupler when the size l₁ is varied.

FIG. 9 shows spectrum diagrams of simulation results showing the frequency characteristics of the element S22 of the S-parameters of the slot-coupling type coupler when the size l₁ is varied.

FIG. 10 shows spectrum diagrams of simulation results showing the frequency characteristics of the element S21 of the S-parameters of the slot-coupling type coupler when the size l₁ is varied.

FIG. 11 shows spectrum diagrams of simulation results showing the frequency characteristics of the element S11 of the S-parameters of the slot-coupling type coupler when the period r is varied.

FIG. 12 shows spectrum diagrams of simulation results showing the frequency characteristics of the element S22 of the S-parameters of the slot-coupling type coupler when the period r is varied.

FIG. 13 shows spectrum diagrams of simulation results showing the frequency characteristics of the element S21 of the S-parameters of the slot-coupling type coupler when the period r is varied.

FIG. 14 shows spectrum diagrams of simulation results showing the frequency characteristics of the element S11 of the S-parameters of the slot-coupling type coupler when the distance s is varied.

FIG. 15 shows spectrum diagrams of simulation results showing the frequency characteristics of the element S22 of the S-parameters of the slot-coupling type coupler when the distance s is varied.

FIG. 16 shows spectrum diagrams of simulation results showing the frequency characteristics of the element S21 of the S-parameters of the slot-coupling type coupler when the distance s is varied.

FIG. 17 shows spectrum diagrams of simulation results showing the frequency characteristics of the element S11 of the S-parameters of the slot-coupling type coupler when the widths w₁ and w₂ are varied.

FIG. 18 shows spectrum diagrams of simulation results showing the frequency characteristics of the element S22 of the S-parameters of the slot-coupling type coupler when the widths w₁ and w₂ are varied.

FIG. 19 shows spectrum diagrams of simulation results showing the frequency characteristics of the element S21 of the S-parameters of the slot-coupling type coupler when the widths w₁ and w₂ are varied.

FIG. 20 shows spectrum diagrams of simulation results showing the frequency characteristics of the elements S11, S22 and S21 of the S-parameters when the complementary metamaterial cells are installed and when the complementary metamaterial cells are not installed.

FIG. 21 shows the distribution of surface currents induced in a conductor patch without complementary metamaterial cells.

FIG. 22 shows the distribution of surface currents induced in a conductor patch having the complementary metamaterial cells.

FIG. 23 is a diagram of the electric field distribution of the electromagnetic wave, which is high-frequency, propagating through a slot-coupling type coupler and a waveguide tube.

FIG. 24 shows a schematic diagram of a slot-coupling type coupler of the second embodiment.

FIG. 25 shows spectrum diagrams of simulation results showing the frequency characteristics of the elements S11, S22 and S21 of the S-parameters when the complementary metamaterial cells are installed and when the complementary metamaterial cells are not installed.

FIG. 26 shows a plan view of a slot-coupling type coupler of the third embodiment from the front side.

FIG. 27 shows a plan view of the slot-coupling type coupler of the third embodiment from the back side.

### DETAILED DESCRIPTION OF ILLUSTRATIVE EMBODIMENTS

### First Embodiment

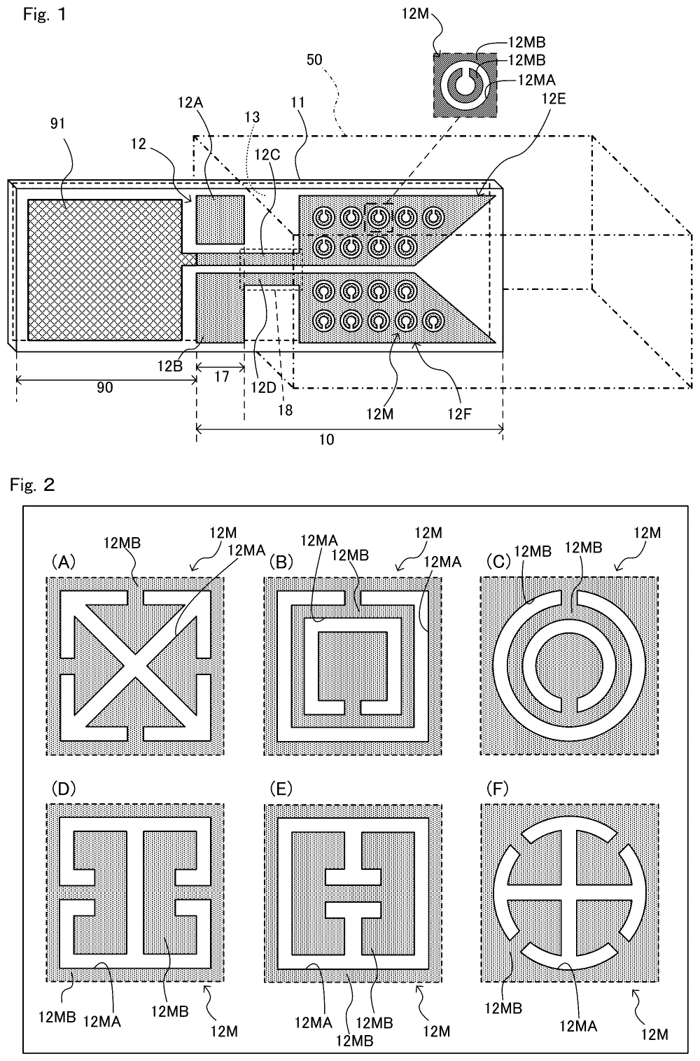

As shown in FIG. 1, a slot-coupling type coupler 10 of the first embodiment is formed in a shape of a plate. The coupler 10 is configured so that at least a part of the coupler 10 is inserted into a waveguide tube 50 through an opening (slot) of the waveguide tube 50. The waveguide tube 50 is rectangular in cross section and hollow. The slot-coupling type coupler 10 connects a high-frequency circuit 91 that generates a high-frequency wave and the waveguide tube 50 that guides the high-frequency wave generated by the high-frequency circuit 91. In FIG. 1, the high-frequency circuit 91 is depicted schematically as a shaded block, and its detailed configuration is omitted. The high-frequency circuit 91 operates in common mode, and the slot-coupling type coupler 10 is configured as a single-end slot-coupling type coupler connecting the circuit 91. The waveguide tube 50 is made of low-resistivity materials such as brass, copper, silver, and aluminum.

The slot-coupling type coupler 10 includes a plate-like substrate 11, a first conductor layer 12 formed on the front surface of the substrate 11 and a second conductor layer 13 formed on the entire back surface of the substrate 11. In this embodiment, a high-frequency circuit 91 is also provided on the substrate 11. In other words, the slot-coupling type coupler 10 and the integrated circuit (IC) chip 90 on which the high-frequency circuit 91 is mounted are integrally formed by a common substrate 11. The high-frequency circuit 91 and the slot-coupling type coupler 10 are formed as one IC chip package.

The substrate 11 is made of any dielectric material. The dielectric materials may

include silicon dielectric such as silicon dioxide, silicon nitride, semiconductors such as gallium arsenide (GaAs) and indium phosphide (InP), and polymers such as polyimide and benzocyclobutene (BCB).

The first conductor layers 12 and the second conductor layers 13 may be made of metal such as gold (Au), copper (Cu), silver (Ag), and platinum (Pt).

The first conductor layer 12 includes rectangular ground planes 12A and 12B, a linear signal line 12C, a linear connecting line 12D, and conductor patches 12E and 12F. The first conductor layer 12 (especially the conductor patches 12E and 12 F) is provided in the electric field (E) plane in the waveguide tube 50. A combination of multiple conductor patches, such as the combination of the conductor patches 12E and 12F, may be considered as one conductor patch.

The ground planes 12A and 12B are grounded by unshown wiring. The ground plane 12B is connected to one end of the connecting line 12D. The other end of the connection line 12D is connected to one end of the conductor patch 12F. With these connections, the connection line 12D and the conductor patch 12F are grounded together via the ground plane 12B.

The signal line 12C passes between the ground planes 12A and 12B and is connected to one end of the conductor patch 12E. The signal line 12C extends parallel to the connection line 12D.

Each of the conductor patches 12E and 12F is a fin-line patch and is formed in the form of a wider band than the signal line 12C and the connection line 12D.

Each of the conductor patches 12E and 12F includes a plurality of complementary metamaterial cells 12M arranged in a periodic array. The complementary metamaterial cells 12M are sub-wavelength elements. Each of the complementary metamaterial cells 12M includes one or more gaps 12MA where a conductor has been removed by etching or other means. The complementary metamaterial cell includes one or more conductor portions 12MB that form the one or more gaps 12MA. With the gaps 12MA having the same geometry as typical metallic metamaterial cells, the complementary metamaterial cells 12M have the complementary geometry of the metallic metamaterial cells (i.e., the conductor portions and gaps are inverted). The gap 12MA is, for example, a hollow portion. The gap 12MA may be filled with a dielectric, such as a portion of the substrate 11. The function and properties of the complementary metamaterial cell 12M are controlled by its geometry. If the geometry is the same as under ideal conditions, the resonant frequencies of the metallic metamaterial cell and the complementary metamaterial cell will be the same. The conductor patches 12E and 12F are symmetrically shaped in the width direction (a vertical direction in FIG. 1) of the substrate 11. The complementary metamaterial cell 12M is hereinafter also referred to simply as cell 12M.

The second conductor layer 13 is a solid ground plane grounded by an unshown wiring and functions as a shield for noise suppression.

Of the slot-coupling type coupler 10, the ground planes 12A and 12B and the portion of the signal line 12C sandwiched therebetween, and the portion of the substrate 11 on which they are formed, constitute the coplanar waveguide (CPW) 17. Of the slot-coupling type coupler 10, the portion of signal line 12C not sandwiched between ground planes 12A and 12B and connecting line 12D constitute dual coplanar strip (CPS) line 18.

In this embodiment of the invention, the electric signal which is the high-frequency wave is generated by the high-frequency circuit 91, and the electromagnetic (EM) wave propagates through the CPW 17. The electric signal is supplied through the signal line 12C to the conductor patch 12E. The electric signal then propagates through conductor patch 12F and connection line 12D. The electromagnetic (EM) wave propagates in the substrate 11 and also partially in the air, and since the permittivity of both media is different, it is assumed that the wave propagates in an inhomogeneous medium. This medium cannot support perfect TEM mode, and since the electric and magnetic (H) fields possess longitudinal components, the mode is described as quasi-TEM.

The electromagnetic wave is emitted from the conductor patches 12E and 12F to the waveguide in waveguide tube 50 (In other words, the above electrical signal transitions to the electromagnetic wave emitted to the waveguide by the conductor patches 12E and 12F). The electromagnetic wave emitted to the waveguide propagate in the waveguide in the TE10 mode. In other words, the propagation mode of the electromagnetic wave is transferred by the conductor patches 12E and 12F from the quasi-TEM mode to the TE10 mode.

The rectangular portion of the second conductor layer 13 opposite the dual CPS line 18 and conductor patches 12E and 12F may not be used, and this rectangular portion may be omitted.

The geometry of the cell 12M is arbitrary. This geometry may be, for example, as shown in (a) to (f) of FIG. 2. The cell 12M is configured to resonate with the high-frequency wave. The geometry of cell 12M is selected to satisfy the conditions that the cell 12M is a subwavelength element and that the cell 12M is excited by an axially time-varying electric field or by a magnetic field applied to the plane of cell 12M. The cell 12M is excited almost entirely by the magnetic field component, and since this behavior is quasi-static, the size of the cell 12M is much smaller than the wavelength of the incident wave.

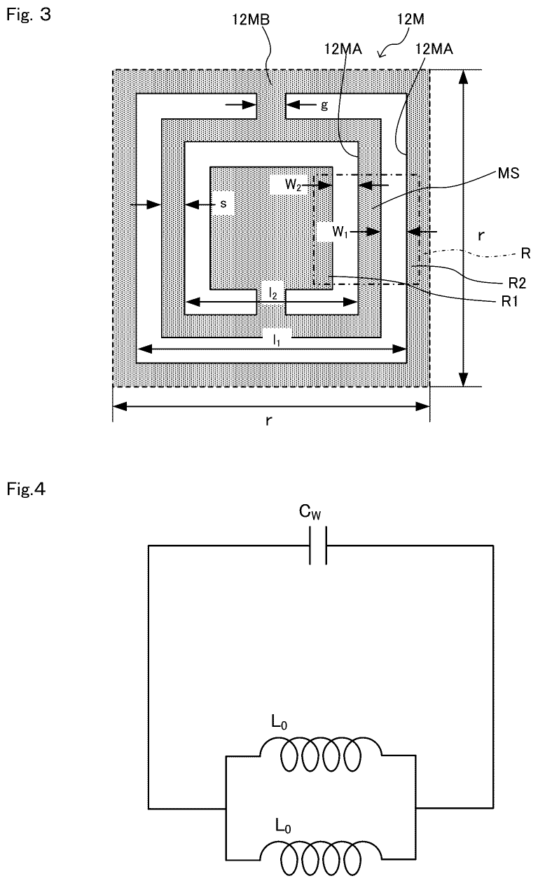

The cell 12M with square shape in FIG. 2(b) (complementary split-ring resonator (CSRR) cell) and the geometric parameters is shown in FIG. 3. In FIG. 3, r is the period of the cell 12M, l₁ is the size of the outer gap ring that is the outer gap 12MA of the two gaps 12MA, l₂ is the size of the inner gap ring that is the inner gap 12MA of the two gaps 12MA, s is the distance between the inner and outer gap rings, w₁ is the width of the outer gap ring, w₂ is the width of the inner gap ring, and g is the width of the conductor that interrupts the gap ring. The equivalent circuit is shown in FIG. 4. The resonance frequency fₒ can be calculated using the following equation (1).

$${f}_{o} = ( 1 / 2 π ) * ( 1 / √ ( L * Cw ) ) \qquad ( 1 )$$

The inductance L is given by the parallel connection of the two inductances of the metal strip MS (FIG. 3) connecting the inner and outer conductor sections left in the cell 12M. The inductance L is the composite inductance Lₒ/2 of the two inductances Lₒ connected in parallel. The inductance Lₒ is obtained from the following equation (2).

$${L}_{o} = P * {L}_{pul} \qquad ( 2 )$$

Where P is the perimeter length of the square outer gap ring, and is obtained from P=4*l₁. If the outer gap ring is circular, P=2πr. Lₚᵤₗ is the inductance per unit length of the area R (FIG. 3) including the metal strip MS, the gaps 12MA, and the conductor portions R1 and R2.

The capacitance C_{W} is the capacitance corresponding to that of a metallic square of size (l₁+l₂)/2−w₁/2 surrounded by a ground plane at a distance w1 of its edge, with the assumption w1=w2.

As an example of the design of the slot-coupling type coupler 10 in the 300 GHz band, full-wave simulations were performed in a simple one-cell 12M scenario to investigate the initial resonance characteristics of the square-shaped cell 12M in FIG. 2(b), and the geometry of cell 12M was optimized.

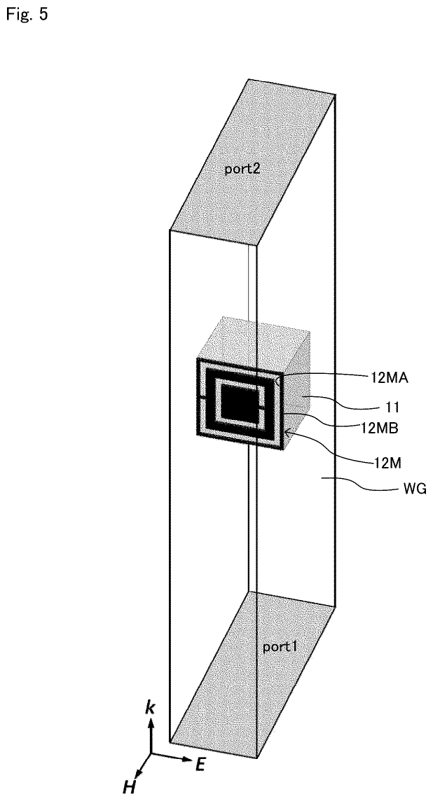

In the first simulation, as shown in FIG. 5, the cell 12M formed on the substrate 11 was placed in a waveguide WG between a port 1 on the CPW17 side and a port 2 on the exit side of the waveguide tube 50. Cell 12M was placed along the plane of the electric field component of the electromagnetic wave propagated by the waveguide WG. In this simulation, the substrate 11 was an InP substrate with dielectric constant εᵣ₁=12.4 and thickness tₛ=50 μm. The aforementioned values are typical for InP-based IC electronics. The initial geometric parameters were r=56 μm, l₁=52 μm, w₁=2₂=4 μm, s=6 μm, and g=2 μm.

In general, the performance evaluation of various devices such as the slot-coupling type coupler 10 is done by analyzing the reflection and transmission coefficients based on S-parameters. Among the S-parameters, S11 is the reflection coefficient at the port 1, S22 is the reflection coefficient at the port 2. In addition, S21 can be used to evaluate the transmission coefficient of a high-frequency wave (electromagnetic wave) from port 1 to port 2. S11 and S22 are used as equivalent values of reflection loss, and a lower value of dB means a smaller loss. S21 is equivalent to insertion loss, with a higher dB value meaning better transmission and lower loss.

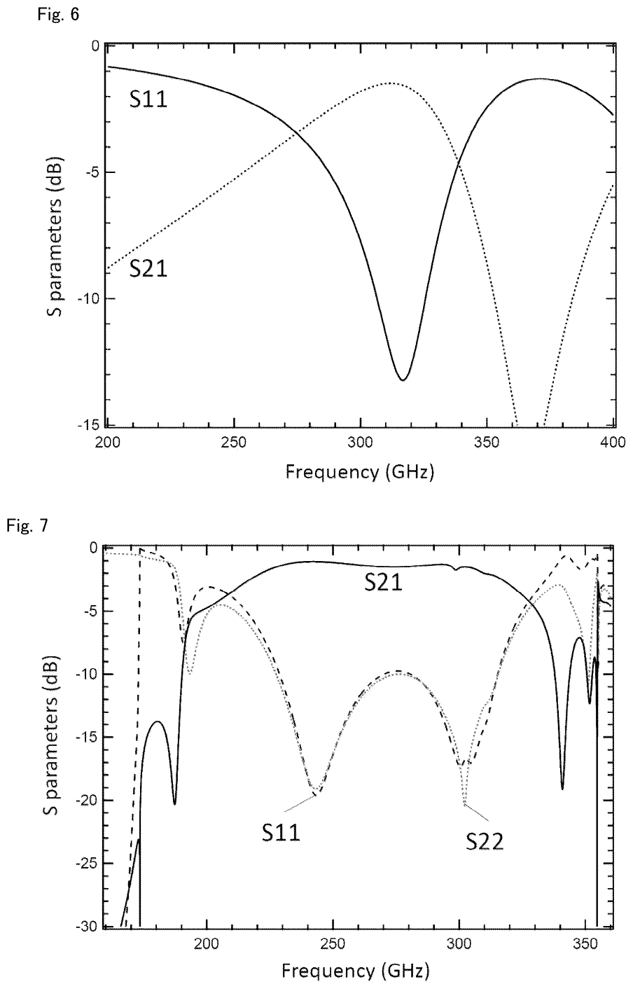

FIG. 6 shows the spectrum diagrams of S11 and S21 among the S parameters of the complementary metamaterial cell 12M optimized in the first simulation above. Relatively high values of the transmission coefficient between 280 and 330 GHz were obtained and above −3 dB were obtained. The geometric parameters of the cell 12M used for the obtained S-parameter values were used as starting values for further optimization of the cell 12M applied to the conductor patches 12E and 12F of the slot-coupling type coupler 10 to improve the performance of the slot-coupling type coupler 10.

FIG. 7 shows S11, S22, and S21 of the S parameters of the slot-coupling type coupler 10 without cells 12M. In the 230-310 GHz range, the S21 values are between −1 and −2 dB, confirming the transmission of an electromagnetic wave with a relatively wide bandwidth. In FIG. 7, two large resonances that are the low-frequency resonance around 245 GHz and the high-frequency resonance around 302 GHz were observed. Due to the asymmetric transition from CPW17 to the waveguide inside waveguide tube 50, the S11 and S22 values show differences.

Next, the size l₁ of the outer gap ring, the width w₁ of the outer gap ring, the width w₂ of the inner gap ring, the distance s between the inner and outer gap rings, and the period r of the cell 12M were examined. Arbitrary fixed values were used for the other parameters. For example, g=2 μm was used.

In the simulations here, as the substrate 11, an InP substrate having the dielectric constant εᵣ₁=12.4, the magnetic permeability μ=1, and thickness tₛ=0.055 mm was used. The above values are typical values in InP-based high-frequency integrated electronics. The first conductor layer 12 was a gold film of 2 μm thickness. The second conductor layer 13 was a 4 μm thick gold film. These thicknesses are based on typical values used in the manufacture of high-frequency circuits. The rectangular waveguide tube 50 was also used. The waveguide dimensions in the waveguide tube 50 were 0.432 mm* 0.864 mm, which corresponds to the WR3.4 type. For the WR3.4 type waveguide, the cutoff frequency of the lowest order mode is 173.5 GHZ and the cutoff frequency of the higher-order mode is 353 GHz.

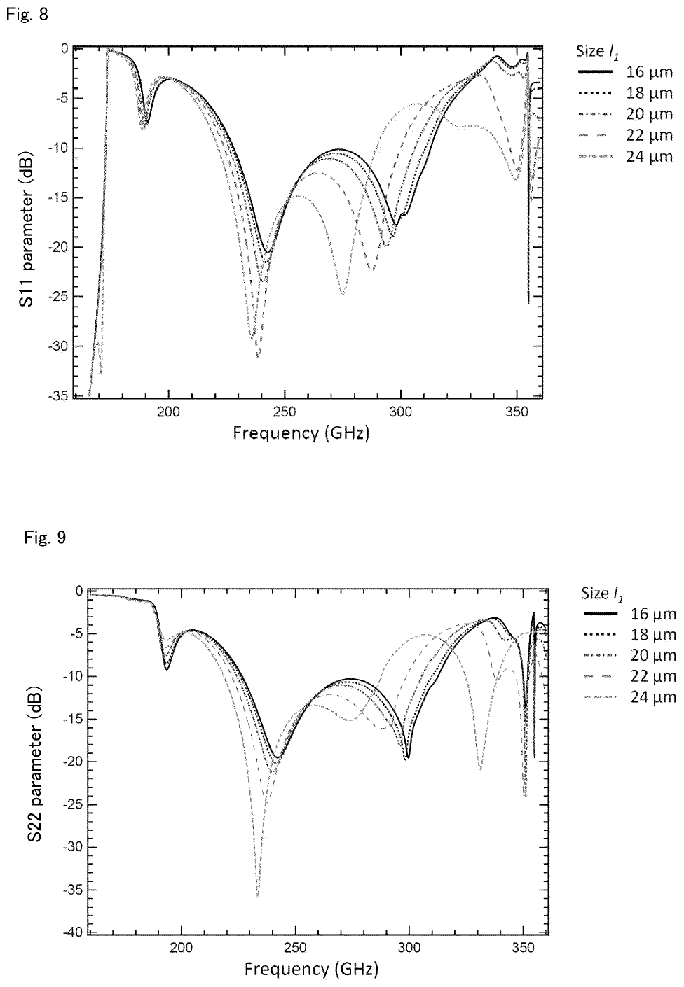

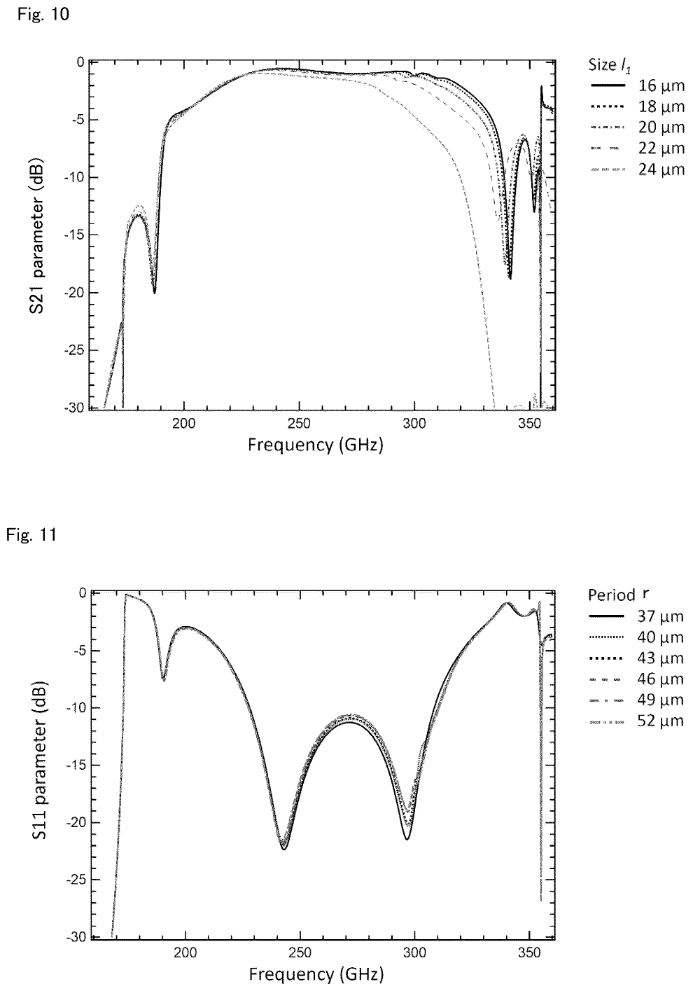

FIGS. 8 to 10 show S11, S22, and S21 when varying the size l₁ of the outer gap ring. The remaining geometric parameters are r=52 μm, w₁=w₂=2 μm, and s=2 μm, and are constant. As l₁ is increased from 16 μm to 24 μm, S11 of FIG. 8 shows that the low-frequency resonance decreases significantly from −20 dB to −30 dB, the high-frequency resonance decreases significantly from −17 dB to −25 dB. S22 of FIG. 9 shows that the low-frequency resonance is reduced from −19 dB to −31 dB. Conversely, S22 with higher resonance frequencies increases. A shift of resonant frequency is also observed. Therefore, it is found that l₁ can be used to tune the slot-coupling type coupler 10 focusing on the operating frequency. As shown in FIG. 10, the broadband characteristics of S21 change when l₁ is varied. Thus, reducing the size of cell 12M, while keeping other geometric parameters constant, resulted in improved broadband characteristics of the slot-coupling type coupler 10.

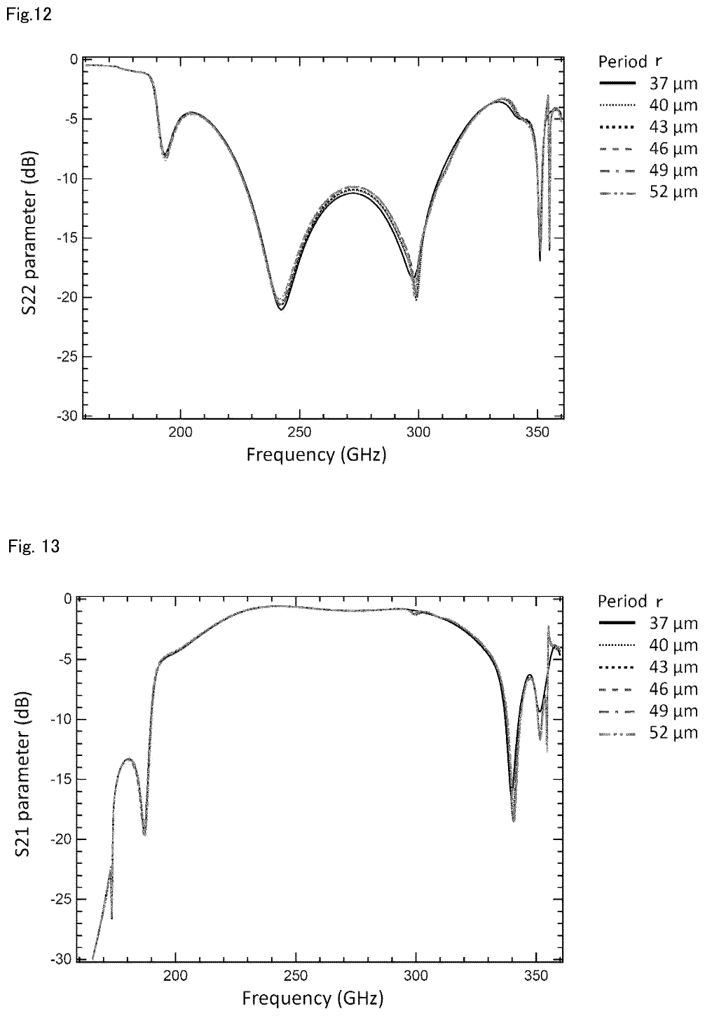

FIGS. 11 to 13 show S11, S22, and S21 when varying the period r. The remaining geometric parameters are w₁=w₂=2 μm, s=2 μm, and l₁=18 μm and are constant. In FIG. 11, when r is decreased from 52 μm to 37 μm S11 decreases by about 1 dB at the low-frequency resonance position and by about 3 dB at the high-frequency resonance position. As shown in FIG. 12, a similar change is observed for S22. r reduction reduces the magnitude of the low-frequency resonance peak and increases the high-frequency resonance peak by about 2 dB. As shown in FIG. 13, the change in S21 is very small, mainly at 300 GHz, which corresponds to a more pronounced change in S11 and S22 at the high-frequency resonance peak. No shift in resonance was observed for changes in r. This effect is related to the fact that, since there is a continuous metal plane between cells 12M, changes in the distance between the cells 12M do not strongly affect the resonance position of the complementary cells 12M.

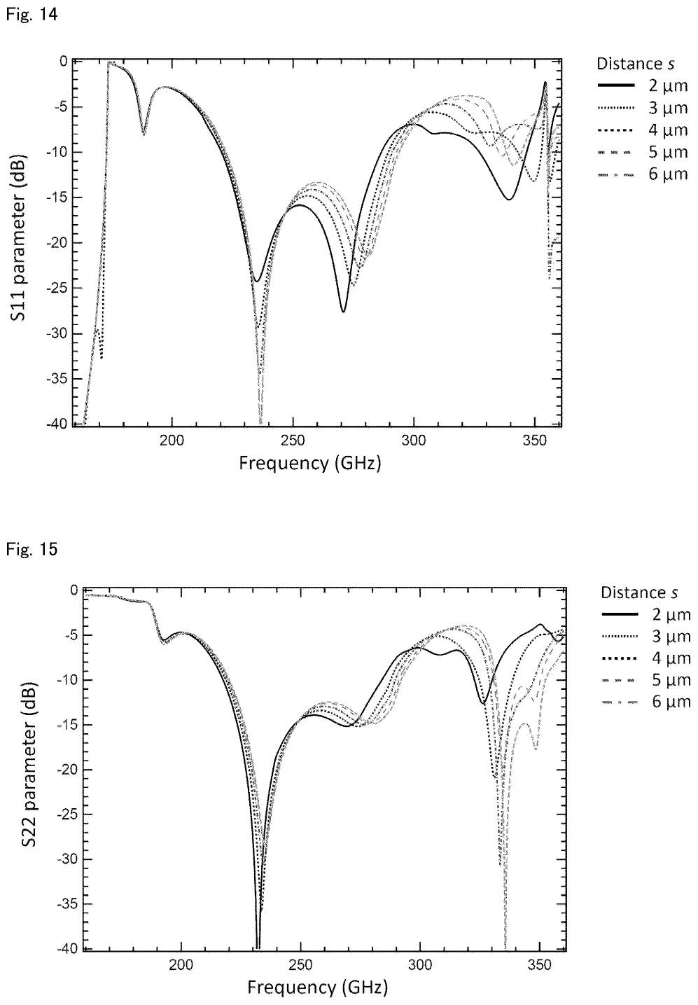

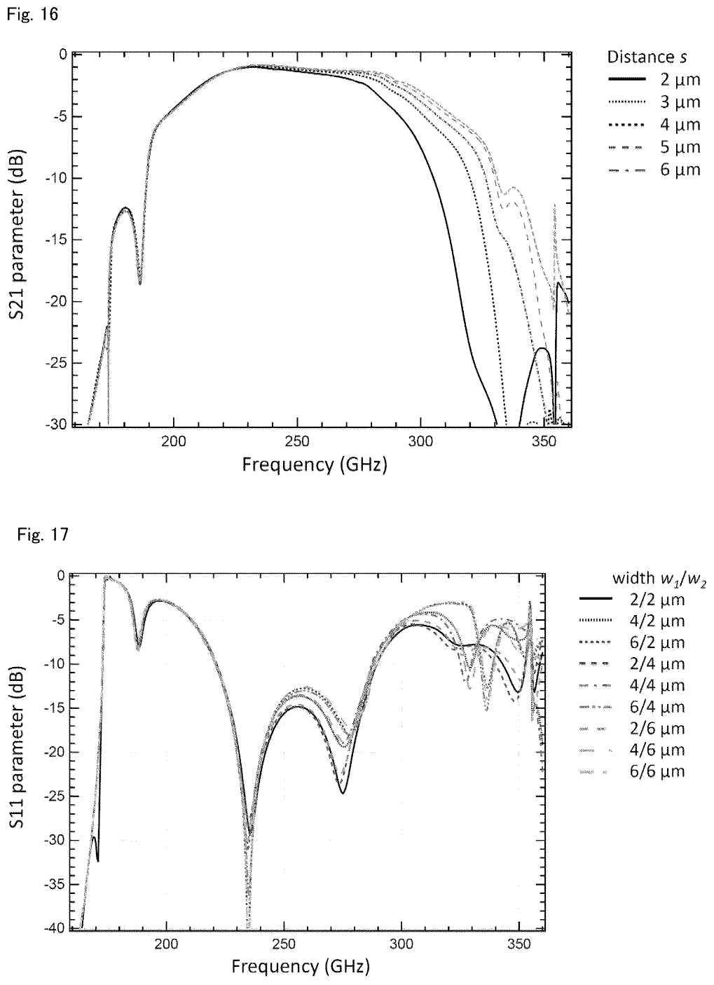

FIGS. 14 to 16 show S11, S22, and S21 when varying the distance s between the inner gap ring and the outer gap ring. The remaining geometric parameters are r=52 μm, w₁=w₂=2 μm, and l₁=18 μm and are constant. As shown in FIG. 14, when s is increased from 2 μm to 6 μm, the low-frequency resonance peak of S11 decreases very significantly and the high-frequency resonance peak of S11 increases slightly. As shown in FIG. 15, when s is increased from 2 μm to 6 μm, S22 changes similarly to s11 and the low-frequency resonance decreases, while the high-frequency resonance also changes significantly. The position of the low-frequency resonance remains constant, while the position of the high-frequency resonance shifts toward higher frequencies with increasing s. When l₁ (the length of the outer gap ring) is constant, changing s results in a decrease in the size 12 of the inner gap ring, a higher resonant frequency can be obtained. As shown in FIG. 16, a larger value of s improves the transmission characteristics of S21 in the higher frequency range, resulting in a wider bandwidth behavior of a slot-coupling type coupler 10.

FIGS. 17 to 19 show S11, S22, and S21 when varying the gap ring width w₁ and w₂. The remaining geometric parameters are r=52 μm, s=2 μm, and l₁=18 μm and are constant. To better visualize the effect of the gap ring width on the loss of the slot-coupling type coupler 10, a combination of w₁ and w₂ was considered. Changing the combination of w₁ and w₂ in the range of 2 to 6 μm also changes the value of the low-frequency resonance and the value of the high-frequency resonance. The lowest value of low-frequency resonance is obtained at w₁=w₂=6 μm. Conversely, high-frequency resonance values increases at w₁=w₂=6 μm. In the combination of w₁=w₂=2 μm, the value of the high-frequency resonance at about 275 GHz is the lowest and the value of the low-frequency resonance is one of the highest.

In FIG. 17, when w₂ is held constant and w₁ is varied, the magnitude of the resonance changes significantly at the low-frequency peak and the high-frequency peak. As shown in FIGS. 8 to 10, the S-parameter characteristics are strongly related to the outer gap ring size l₁, so if l₁ is held constant and w1 is increased, the size 12 of the inner gap ring becomes smaller, which has a significant effect on the resonance of the cell 12M. In S11, the low-frequency and high-frequency resonances are found to shift toward the low-frequency side. The shift of the low-frequency resonance is related to a change in the width w₁ and is relatively small. The shift of the high-frequency resonances is related to the change in the width w₁, and hence in the size 12 of the inner gap ring, so a larger shift is observed. For comparison, if the width w₁ of the outer gap ring is kept constant and the width w₂ of the inner gap ring is varied, only the inner gap ring size 12 is changed and the effect on the resonance behavior is considerably smaller.

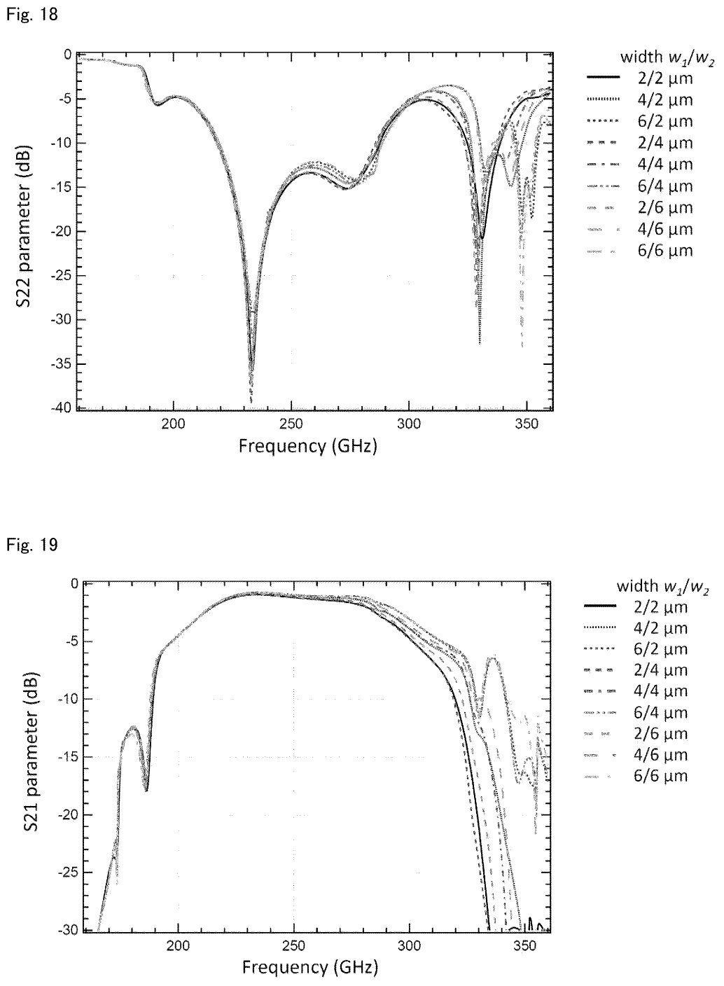

As shown in FIG. 18, the same behavior is observed for S22. The lowest resonance value is obtained at w₁=w₂=2 μm for both low and high-frequency resonance. The highest resonance value is obtained at w₁=w₂=6 μm. The shift at low-frequency resonance is relatively small, but at high-frequency resonance, a much larger shift is observed toward higher frequencies when the outer gap ring is increased from w₁=2 μm to w₁=6 μm.

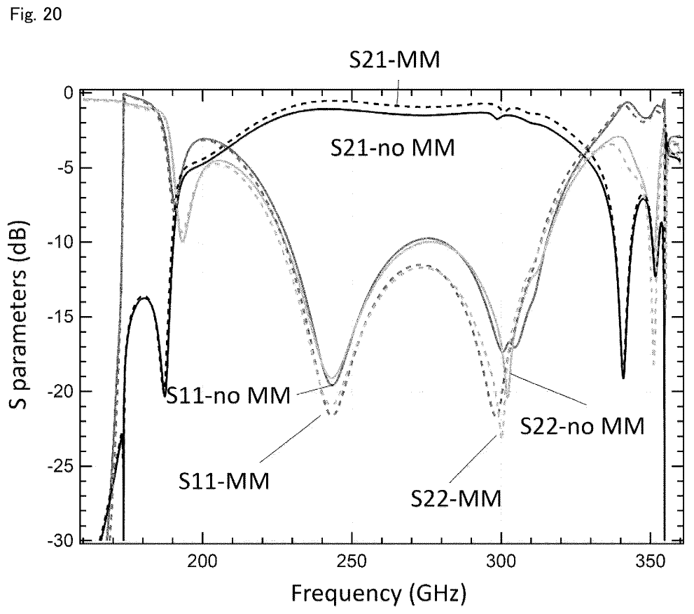

As shown in FIG. 19, when w₁ and we are increased from 2 μm to 6 μm, S21 increases in the higher frequency range, which is related to the fact that high resonance shifts to the lower frequency side when w₂ is small. Therefore, to obtain a high transmission spectrum in the high-frequency range, the width w₂ of the inner gap ring of cell 12M must be increased. On the other hand, if the size l₂ of the inner gap ring is kept constant and the size l₁ of the outer gap ring is varied by increasing w₁, lower resonance values can be obtained with the same broadband characteristics.

FIG. 20 shows S11, S22, and S21 of the slot-coupling type coupler 10 when cells 12M are provided and S11, S22, and S21 of the slot-coupling type coupler when cells 12M are not provided. In FIG. 20, “-MM” is added to S11, S22, and S21 of the former, and “-no MM” is added to S11, S22, and S21 of the latter. The geometric parameters of cell 12M are w₁=6 μm, w₂=2 μm, sb=4 μm, and l₁=32 μm.

As FIG. 20 shows, compared to a slot-coupling type coupler without cells 12M, the broadband characteristics of S21 of the slot-coupling type coupler 10 with cells 12M are improved. In addition, S11 and S22 are generally reduced, especially in the two resonance peaks, which means that the reflection loss has been reduced in this process. Finally, the magnitude of S21 has also increased, which means that the insertion loss of the slot-coupling type coupler 10 has also been reduced. Since the main purpose of this embodiment was to improve the broadband characteristics and reduce the insertion loss, the reflection loss was not reduced as significantly.

Despite the narrowband characteristics, by combining cells of different dimensions, for example by increasing the size of cell 12M or changing the distances, lower reflection loss is achieved.

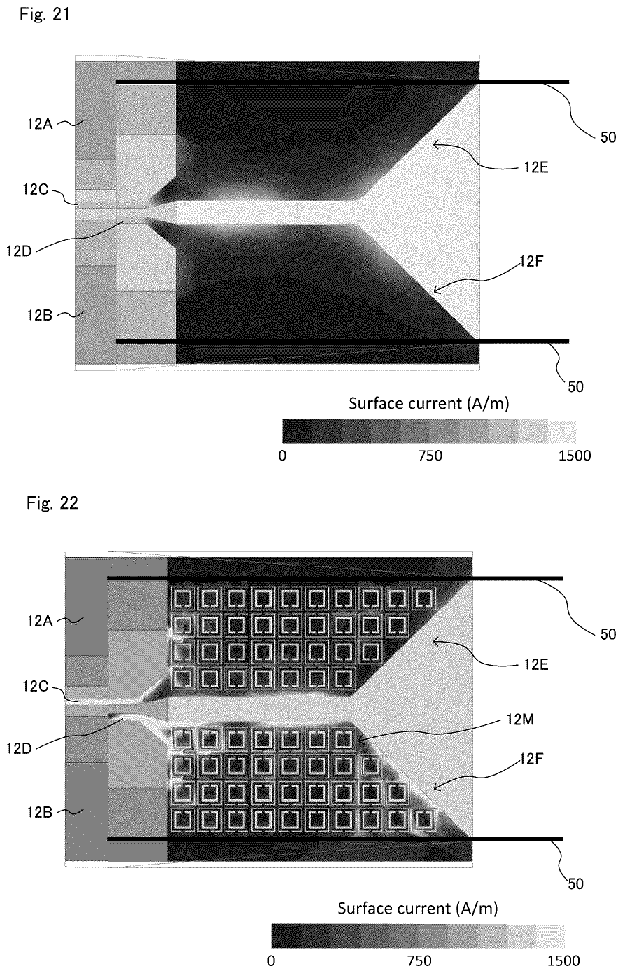

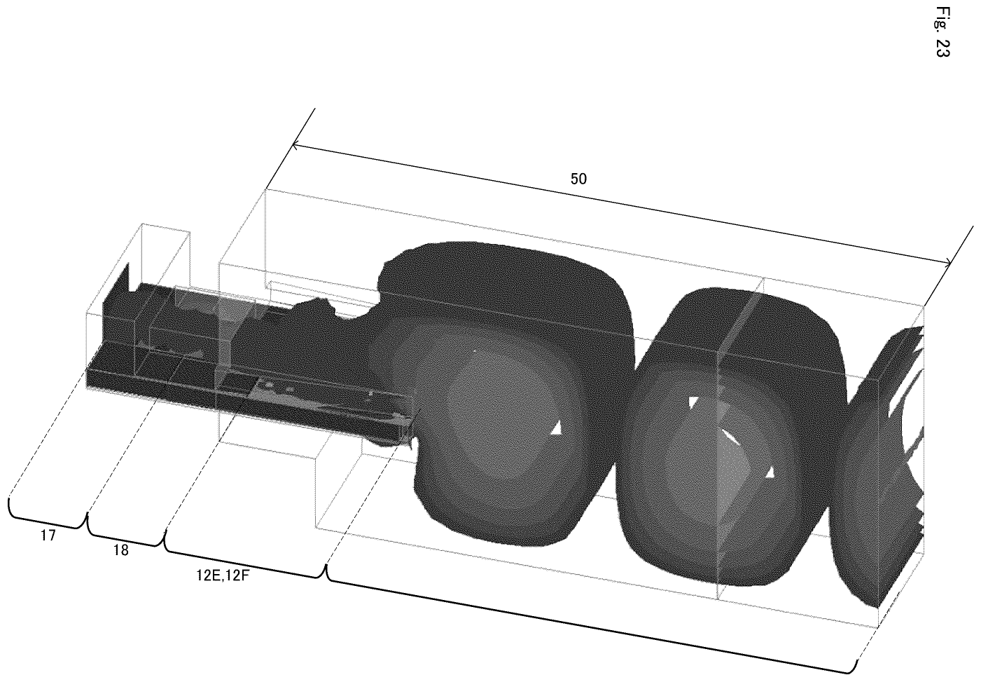

The Cell 12M adjusts the impedances of the conductor patches 12E and 12F to improve the transition efficiency between the quasi-TEM mode and the TE10 mode. To better understand the resonance mechanism of cell 12M, the surface current distributions on the conductor patches 12E and 12F are shown in FIGS. 21 and 22.

As shown in FIG. 21, the induced surface currents in conductor patches 12E and 12F without cells 12M are mainly concentrated in the gap area between the two conductor patches 12E and 12F, with little flow in conductor patches 12E and 12F. As shown in FIG. 22, the induced surface currents of the conductor patches 12E and 12F are significantly increased compared to those in FIG. 21. This is due to the strong resonance effect by the cells 12M. This change in the distribution of surface currents allows for higher efficiency in the conversion of the electric signal to the electromagnetic wave.

FIG. 23 shows the electric field distribution in the slot-coupling type coupler 10 and the electric field distribution of the electromagnetic wave propagating through the waveguide in waveguide tube 50. In the simulation, the input electromagnetic wave is the signal input to the CPW 17 and propagates in the coupler 10. The electric field in the quasi-TEM mode is initially focused in the area of the CPW 17 and then transmitted through the area of the dual CPS line 18 into the area of the conductor patches 12E and 12F. The electromagnetic wave is radiated into the waveguide 50 by the conductor patches 12E and 12F and propagates in the TE10 mode observed in the simulation through the waveguide tube 50.

As described above, the slot-coupling type coupler 10 that connects the high-frequency circuit 91 to the waveguide tube 50 has a substrate 11 that is inserted into the waveguide tube 50, and conductor patches 12E and 12F provided on the substrate 11 and configured to emit the high-frequency wave (the electric signal or the EM wave) generated by the high-frequency circuit 91 into the waveguide tube 50. Each of the conductor patches 12E and 12F has complementary metamaterial cells 12M. Each complementary metamaterial cell 12M includes one or more conductor portions 12MB forming (compartmentalizing) one or more gaps 12MA that conductors are removed (where no conductors exist). The substrate 11 may be inserted at least a portion thereof into the waveguide tube 50. For example, this at least the portion includes all portions where the conductor patches 12E and 12F are provided.

The above configuration of the cell 12M can reduce insertion loss and or reflection loss. In addition, the cell 12M can improve the transition efficiency between the quasi-TEM mode and the TE10 mode. In addition, the cell 12M allows for a wider frequency band with lower losses.

The slot-coupling type coupler 10 also has the coplanar waveguide 17 in front of the conductor patches 12E and 12F, which reduces noise.

The conductor patches 12E and 12F are configured to change the mode of the high-frequency wave, and the cell 12M increases the efficiency of mode transitions, here between the quasi-TEM mode and the TE10 mode.

By also providing the high-frequency circuit 91 on the substrate 11, the slot-coupling type coupler 10 and the IC chip 90 can be formed as one integrated package.

The cell 12M is a sub-wavelength element that has a size smaller than the wavelength of the high-frequency wave, or is formed in such a shape that the cell 12M resonates with the high-frequency wave, thereby achieving a strong resonance effect.

In addition, since the probe and ridge coupler are not used in this embodiment, the problem of increased fabrication complexity and the large losses that occur by wire bonding can be mitigated. In addition, since the slot-coupling type coupler 10 is fabricated on a common substrate 11 with the IC chip 90, welding losses and instability can be avoided.

The cell 12M is formed together with the CPW17 (or microstrip) and the conductor patches 12E and 12F. Therefore, the cell 12M can be formed using conventional coupler manufacturing processes. The cell 12M is easily added by changing the design of the mask used in the photolithography process for making the conductor patches 12E and 12F.

### Second Embodiment

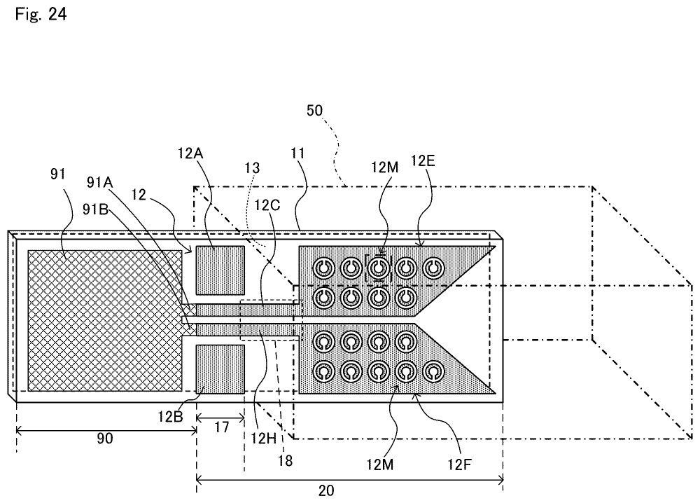

In the second embodiment, as shown in FIG. 24, the high-frequency circuit 91 is configured as a differential output circuit effective for LO leakage cancellation. The slot-coupling type coupler 20 is a double-end type. Instead of the connection line 12D, a second signal line 12H is formed as part of the first conductor layer 12. The second signal line 12H connects the conductor patch 12F to the high-frequency circuit 91. The CPW 17 is a dual CPW that sandwiches the two signal lines 12A and 12H by the ground planes 12A and 12B. The conductor patches 12E and 12F are formed symmetrically with each other. The conductor patches 12E and 12F are connected to a pair of first and second output terminals 91A and 91B of the high-frequency circuit 91 respectively, and are used for transmission of the electric signal and for emitting the electromagnetic wave.

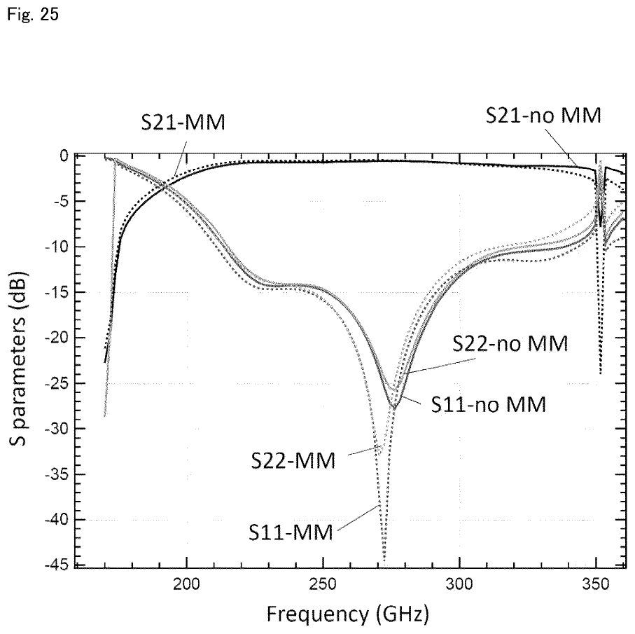

FIG. 25 shows S11, S22, and S21 of the slot-coupling type coupler 10 when the cells 12M are provided, and S11, S22, and S21 of the slot-coupling type coupler when the cells 12M are not provided. When the cell 12M is provided, the amplitudes of S11 and S22 are greatly reduced compared to those without the cell 12M. S11 decreases by 17 dB from about −28 dB to about −45 dB, and S22 decreases by 7 dB from about −26 dB to about −33 dB. S21 shows broadband transmission in both cases with and without the cell 12M, but the introduction of the cell 12M increases transmission at lower frequencies and decreases transmission at higher frequencies. The change in the broadband transmission is small in this case, with a small decrease in insertion loss and a larger decrease in reflection loss. Thus, the cell 12M improved the transition performance from electric signal to electromagnetic wave.

In this or other embodiments, cell 12M in either of the conductor patches 12E and 12F may be omitted.

### Third Embodiment

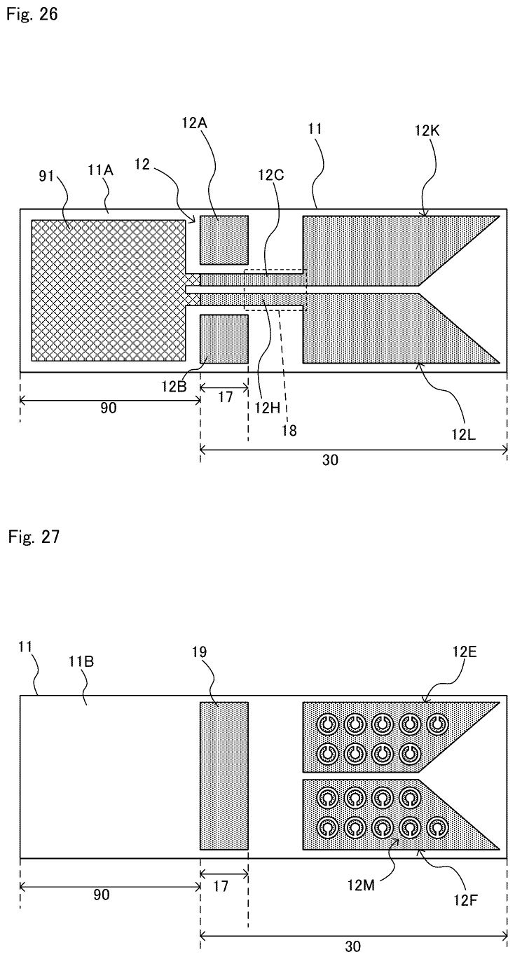

In the slot-coupling type coupler 30 of the third embodiment, as shown in FIGS. 26 and 27, the conductor patches 12E and 12F are provided on the back surface 11B of the substrate 11. Furthermore, the conductor patches 12E and 12F are grounded by an unshown wiring. In addition, one ground plane 19 opposing the ground planes 13A and 13B is formed on the back surface 11B. On the front surface 11A of the substrate 11, the first conductor layer 12 as in the second embodiment is formed, but instead of the conductor patches 12E and 12F, solid conductor patches 12K and 12L having no cell 12M are formed. The conductor patches 12K and 12L have the same outline as the conductor patches 12E and 12F, respectively. The conductor patches 12K and 12L and the conductor patches 12E and 12F, respectively, face each other via the substrate 11. This configuration improves the broadband characteristics. The cell 12M introduces capacitance and inductance, which affect the characteristics of the high-frequency waveguide and increase its broadband behavior. A combination of conductor patches 12E, 12F, 12K, and 12L may be considered as one conductor patch on the substrate that radiates the high-frequency wave from the high-frequency circuit 91 into the waveguide 50.

### Scope of the Invention

Although the invention has been described above with reference to embodiments and variations, the invention is not limited to the above embodiments and variations. For example, the present invention includes various modifications to the above embodiments and variations that can be understood by those skilled in the art within the scope of the technical concept of the invention. Each of the configurations listed in the above embodiments and variations can be combined as appropriate to the extent that there is no contradiction.

### Reference Signs List

10 . . . Slot-coupling type coupler, 11 . . . Substrate, 12 . . . first conductor layer, 12A and 12B . . . ground plane, 12C . . . signal line, 12D . . . connecting line, 12E and 12F . . . conductor patch, 12H . . . second signal line, 12K and 12L . . . conductor patch, 12M . . . complementary metamaterial cell, 12MA . . . gap, 12MB . . . conductor portion, 13 . . . second conductor layer, 13A . . . ground plane, 13B . . . ground plane, 17 . . . coplanar waveguide (CPW), 18 . . . Dual coplanar stripline, 19 . . . Ground plane, 20 . . . Slot-coupling type coupler, 30 . . . Slot-coupling type coupler, 50 . . . waveguide tube, 90 . . . IC chip, 91 . . . high-frequency circuit

1.-7. (canceled)

8. A slot-coupling type coupler for connecting a high-frequency circuit to a waveguide tube, comprising:
a substrate, at least a part of the substrate being inserted into the waveguide tube; and
a conductor patch on the substrate and configured to emit a high-frequency wave generated by the high-frequency circuit into the waveguide tube, the conductor patch comprising a first conductor patch on a first side of the substrate and includes a complementary metamaterial cell including one or more conductor portions and one or more gaps.

9. The slot-coupling type coupler according to claim 8, further comprising:
a coplanar waveguide tube including a portion of the substrate in front of the conductor patch, the coplanar waveguide tube being configured to transmit the high-frequency wave.

10. The slot-coupling type coupler according to claim 8, wherein
the conductor patch is configured to change a mode of the high-frequency wave.

11. The slot-coupling type coupler according to claim 8,
wherein the high-frequency circuit is on the substrate.

12. The slot-coupling type coupler according to claim 8, wherein
the complementary metamaterial cell has a shape configured to resonate with the high-frequency wave.

13. The slot-coupling type coupler according to claim 8, wherein
the high-frequency circuit is a differential output circuit including a first output terminal and a second output terminal;
the first conductor patch is connected to the first output terminal; and
the conductor patch further comprises a second conductor patch on the first side of the substrate, the second conductor patch having a shape symmetrical to the first conductor patch, and connected to the second output terminal.

14. The slot-coupling type coupler according to claim 8, wherein
the conductor patch further comprises a second conductor patch on a second side of the substrate opposite the first side;
the second conductor patch is opposite the first conductor patch via the substrate and does not include a complementary metamaterial cell; and
the first conductor patch is grounded.

15. A slot-coupling type coupler for connecting a high-frequency circuit to a waveguide tube, comprising:
a conductor patch on a first side of a substrate, the conductor patch comprising:
a plurality of complementary metamaterial cells arranged in a periodic array,
wherein each complementary metamaterial cell includes:
one or more conductor portions, and
one or more gaps between the one or more conductor portions;
wherein the complementary metamaterial cells are configured to resonate with a high-frequency wave generated by the high-frequency circuit; and
wherein the conductor patch is configured to emit the high-frequency wave into the waveguide tube.

16. The slot-coupling type coupler of claim 15, wherein the complementary metamaterial cells are configured to adjust an impedance of the conductor patch to improve transition efficiency between a quasi-TEM mode and a TE10 mode.

17. The slot-coupling type coupler of claim 15, further comprising:
a coplanar waveguide on the first side of the substrate, the coplanar waveguide connected to the conductor patch and configured to transmit the high-frequency wave to the conductor patch.

18. The slot-coupling type coupler of claim 15, further comprising:
a second conductor patch on a second side of the substrate opposite the first side, wherein the second conductor patch does not include complementary metamaterial cells.

19. The slot-coupling type coupler of claim 18, wherein:
the conductor patch on the first side of the substrate is configured to be grounded; and
the second conductor patch has an outline matching the conductor patch on the first side of the substrate.

20. The slot-coupling type coupler of claim 15, wherein:
the slot-coupling type coupler is configured to connect to a high-frequency circuit, the high-frequency circuit being a differential output circuit including a first output terminal and a second output terminal;
the conductor patch is a first conductor patch configured to be connected to the first output terminal; and
the slot-coupling type coupler further comprises a second conductor patch on the first side of the substrate, the second conductor patch having a shape symmetrical to the first conductor patch and configured to be connected to the second output terminal.

21. A method of manufacturing a slot-coupling type coupler, comprising:
forming a first conductor layer on a first side of a substrate;
patterning the first conductor layer to form a conductor patch, wherein patterning the first conductor layer comprises:
creating a plurality of complementary metamaterial cells arranged in a periodic array within the conductor patch, each complementary metamaterial cell including:
a plurality of conductor portions, and
one or more gaps between the conductor portions;
wherein the complementary metamaterial cells are configured to resonate with a high-frequency wave; and
configuring the conductor patch to emit the high-frequency wave into a waveguide tube.

22. The method of claim 21, wherein creating the plurality of complementary metamaterial cells comprises:
etching the first conductor layer using a photolithography mask with a pattern corresponding to the complementary metamaterial cells to form the conductor portions and the gaps.

23. The method of claim 21, further comprising:
forming a coplanar waveguide on the first side of the substrate, the coplanar waveguide connected to the conductor patch and configured to transmit the high-frequency wave to the conductor patch.

24. The method of claim 21, further comprising:
forming a second conductor layer on a second side of the substrate opposite the first side; and
patterning the second conductor layer to form a ground plane.

25. The method of claim 21, wherein patterning the first conductor layer further comprises:
forming a signal line connected to the conductor patch; and
forming ground planes adjacent to the signal line to create a coplanar waveguide.

26. The method of claim 21, further comprising:
selecting geometric parameters for the complementary metamaterial cells based on a desired operating frequency range of the slot-coupling type coupler, wherein the geometric parameters comprise a period of the complementary metamaterial cells, a size of an outer gap ring, a size of an inner gap ring, a distance between the inner and outer gap rings, a width of the outer gap ring, or a width of the inner gap ring.

27. The method of claim 21, further comprising:
forming a second conductor patch on the first side of the substrate, the second conductor patch having a shape symmetrical to the conductor patch;
wherein the conductor patch is configured to connect to a first output terminal of a differential output high-frequency circuit, and the second conductor patch is configured to connect to a second output terminal of the differential output high-frequency circuit.
